(19) United States
(12) Patent Application Publication
(10) Pub. No.: US 2008/0262933 A1
(43) Pub. Date: Oct. 23, 2008

(54) Method And System For Modifying And Transmitting Data Between A portable Computer And A Network

(75) Inventor: Jussi Ketonen, Palo Alto, CA (US)

Correspondence Address: DERGOSITS & NOAH LLP, FOUR EMBARCADERO CENTER, SUITE 1450, SAN FRANCISCO, CA, 94111, US

(73) Assignee: TOP MOXIE, INC., Palo Alto, CA (US)

(21) Appl. No.: 12/166,301

(22) Filed: Jul. 1, 2008

Related U.S. Application Data
(62) Division of application No. 10/407,788, filed on Apr. 4, 2003.
Application No. 10/407,788 is a continuation-in-part of application No. 09/696,558, filed on Oct. 25, 2000, now Pat. No. 6,973,478.
Application No. 09/696,558 is a continuation-in-part of application No. 10/082,495, filed on Feb. 22, 2002, now Pat. No. 7,035,828.
Application No. 10/082,495 is a continuation-in-part of application No. 09/696,558, filed on Oct. 25, 2000, now Pat. No. 6,973,478.
(60) Provisional application No. 60/371,865, filed on Apr. 10, 2002.
(60) Provisional application No. 60/271,170, filed on Feb. 23, 2001.

(51) Int. Cl. G06Q 30/00; G06Q 99/00; G06N 5/02

(52) U.S. Cl. 705/14; 705/1; 706/10

(57) ABSTRACT

A web agent system automatically performs tasks for a computer user based upon the actions of the user. The web agent system includes a local assistant program stored on a user computer which performs various functions based upon rules and data. The local assistant program and rules are downloaded from a first local assistant server maintained by an application service provider. The data used with the rules by the local assistant program is downloaded from a second local assistant server maintained by an assisted merchant. The web agent monitors the user's actions and performs tasks related to the detected actions based upon the rules and data. The web agent also automatically updates the rules and data.

### RELATED APPLICATIONS

This application is a divisional of co-pending U.S. patent application Ser. No. 10/407,788, filed Apr. 4, 2003, titled “Method And System For Retrieving And Analyzing Data To Customize The Behavior Of Automated Web Agents” which is a continuation-in-part of U.S. patent application Ser. No. 09/696,558, now U.S. Pat. No. 6,973,478, filed Nov. 25, 2000 titled “Autonomous Local Assistant For Managing Business Processes” and a continuation-in-part of U.S. patent application Ser. No. 10/082,495, now U.S. Pat. No. 7,035,828, filed Feb. 22, 2002 titled “Method And System For Modifying And Transmitting Data Between A Portable Computer And A Network.” U.S. patent application Ser. No. 10/407,788, is also the nonprovisional patent application of U.S. Provisional Application No. 60/371,865 filed Apr. 10, 2002. U.S. patent application Ser. No. 10/082,495, is also the nonprovisional patent application of U.S. Provisional Application No. 60/271,170 filed Feb. 23, 2001. U.S. patent application Ser. Nos. 09/696,558, 10/082,495, 60/371,865 and 60/271,170 are hereby incorporated by reference.

### BACKGROUND

A downloadable web agent is a package of code and data that can be installed onto a user's computer. Once installed, the web agent can perform specific tasks using the internet through the user's browser such as: requesting information, downloading programs, transmitting reminders or spidering (to summarize job opportunities). A problem with web agents is that their actual behavior is very hard to change after installation. What is needed is a web agent having behavior characteristics which are easily and automatically changed.

### SUMMARY OF THE INVENTION

The inventive system is an easily modifiable web agent which performs tasks in response to the user's actions. The inventive web agent system uses three primary hardware components: a user computer, a first administrative system maintained by the application provider and a second administrative system maintained by an assisted merchant. The web agent performs specific functions based upon rules and data. The general actions of the web agent are defined by the rules and the data controls the user inputs to be monitored and the content of the web agent's responses.

To install the web agent, the local assistant program and rules are first loaded onto the user's computer from the application provider's web site. The data used with the program is then downloaded from the assisted merchant's web site. When the web agent is active, the actions of the user are monitored. The observed actions of the system may include the URLs visited by the user and trigger strings which are specific text inputs by the user. The web agent recognizes specific user actions and responds by performing tasks related to the recognized actions.

In an embodiment, the inventive system is used to provide supplemental information in support of the user's research. For example, if the user uses the computer's CD player or MP3 player, the web assistant may determine which artist is being played and search for additional information related to the artist or song being played. The web agent may then display this information to the users.

Alternatively, the user may be performing research using keyword inputs to a search engine. The web agent may detect the use of a specific search engine and determine the key words input by the user. The web agent may then perform a similar search on a different search engine to provide supplemental search results to the user.

In an embodiment, the inventive system is used as part of a user rewards program for online shopping. The users may join the rewards program which results in a web agent program being loaded onto the user's computer. While using the internet, the web agent program monitors the URLs visited by the user. The stored data used by the web agent includes a listing of URLs and the content of the actions to perform when these URLs are accessed. When the web agent detects a listed URL a specific response is triggered. The response may be a special offer, rewards points or other information which may be presented in various forms including: a pop up window, another browser window or a search side panel. Alternatively or in combination with the URL detection, the web agent may also detect triggerstrings input by the user. The inventive system may respond to a listed triggerstring in a manner similar to that of the URL. When listed URLs or triggerstrings are not detected, no action is taken by the web agent and the user's computer functions in an unassisted manner.

The inventive web agent also provides methods for automatically updating both the rules and the data. The rules used by the web agent periodically need to be updated by the application provider to incorporate improvements and maintain compatibility with new hardware and software. Similarly, the data used with the rules should also be updated regularly to change the content and look of the web agent's responses. By regularly updating the rules and data the performance of the web agent is enhanced and the user's interest is maintained. The updating process may be performed automatically by the web agent which may go to the application provider web site for rule updates and the assisted merchant web site for data updates. The format of the updates may be in HTML or XML which are easily downloaded and interpreted by the web agent.

### BRIEF DESCRIPTION OF THE DRAWINGS

The invention is herein described, by way of example only, with reference to embodiments of the present invention illustrated in the accompanying drawings, wherein:

FIG. 1 is a diagram of the web agent system;

FIG. 2 is a flow chart of the administrative operations of the web agent; and

FIG. 3 is a flow chart of the normal operation of the local assistant system.

### DETAILED DESCRIPTION

The inventive web agent system provides customized behavior based the user's actions which is easily updateable. The present invention provides a system and method that enables an internet entity, referred to herein as the “web agent”, to provide highly efficient and flexible relevance-based information which supplements the computer user's own actions. The web agent is a local assistant program which performs various functions based upon rules and data. The application servers provide rules and data for controlling the functionality of the web agent and the assisted merchant servers provide data which controls the content displayed by the web agent.

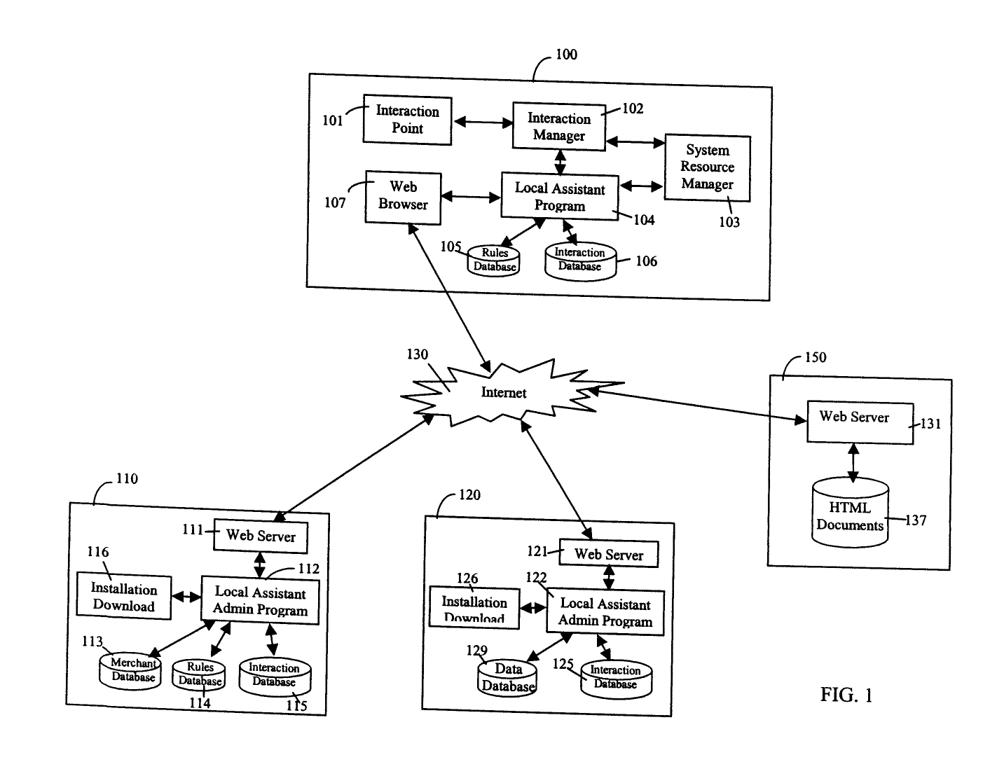

FIG. 1 illustrates the general architecture of local assistant and includes: a user computer 100 running a local assistant client-side computer program 104, a local assistant administrative system 110 and an assisted merchant system 120 all of which are linked together by the Internet 130. A local assistant program is stored on each of the components. A local assistant program 104 is stored on the user's computer 100, a first local assistant administrative program 112 is stored on the application provider's server 110, and a second local assistant administrative program 122 is stored on the assisted merchant's server 120. Note that one local assistant administrative system 110 can be used with many user computers 100 and assisted merchant servers 120.

The user computer 100 can be any type of computing device that allows a user to interactively browse web sites via a web browser 107 and, preferably, to control other devices such as media players, CD player, mouse, keyboard, pointing device, location sensors, etc., represented in FIG. 1 by an interaction point 101. The software used to control the devices such as Win Amp, etc. are represented by an interaction manager 102. The web browser 107 itself may also be considered an example of an interaction manager 102. The user's computer 100 could be a personal computer (PC) connected to the Internet 130 via a modem, or a hand-held or wearable computer connected to the Internet 130 by wireless communication.

The local assistant program 104 comprises a rule interpreter that is driven by local databases containing a downloadable ruleset stored locally on the rules database 105 in the user computer 100. The local assistant program 104 can perform various functions such: monitoring client interaction activity, determining applicable rules and interpreting rules. The local assistant program 104 also manages the local ruleset database 105 and the local interaction database 106. The local assistant program 104 and current rules are downloaded from the installation download 116 through the first local assistant administrative program 112 of the application provider server 110. The data which is used with the rules by the local assistant program 104 is downloaded from the second local assistant administrative program 122.

The first local assistant administrative program 112 acts as a download server for the client-side software, manages rulesets distribution and collects statistics generated by the rule executions. The first local assistant administrative program 112 resides on a computer system 110 operated by the web agent application provider. Internet 130 interactions between the local assistant program 104 and the first local assistant administrative program 112 are secured so that the delivered/installed code and ruleset updates are those intended by the application provider.

The second local assistant administrative program 122 on the assisted merchant server acts as a download server for the distribution of data used with the rules. The second local assistant administrative program 122 resides on a computer system 120 operated by the assisted merchant who may subscribe to the application provider's web assistant. Internet interactions between the client-side software 104 and the second local assistant administrative software 122 are also secured. Further the first local assistant administrative program 112 and the second local assistant administrative program 122 may also communicate to share information regarding the most current rules updates and statistical information regarding the user's actions.

During normal operations, the Local Assistant program 104 interacts with the system resource manager 103 to determine current client activity such as opening web browser windows, inputting specific search words or running CD players. For each activity of interest, the Local Assistant program 104 constructs an information context from data obtained from the interaction manager 102. This information could be as simple as the name of a performing artist, or as complicated as the HTML text of a web document. This information context extends the information context implicit in the local interaction data database 106. The local assistant program 104 then queries the local ruleset database 105 for applicable rules and data. The local assistant program 104 then schedules and executes the rules using a simple, conventional scheduling algorithm to order multiple execution tasks.

The local assistant program 104 includes various components that work together including: an interaction data manager, a rules interpreter, a rules manager and an interaction data manager. The interaction data manager provides access to the local interaction database 106 and manages creation, lookup, update and deletions of named data elements. The rule interpreter determines actions to take based on the rule, data and information context that it is given. Possible rules actions include: invoking other rules, retrieving HTML data, requesting operations on the interaction data database 106, requesting operations on the ruleset database 105, posting updates to the local assistant administrative site 110, and presenting information to and interacting with the user. The ruleset manager provides functionality to query the local ruleset and data to download updated rulesets from the application provider server 111 and updated data from the assisted merchant server 121.

The first local assistant administrative system 110 maintained by the application service provider includes functions for: downloading the local assistant client-side application 116, updating the local assistant rules, uploading interaction data summaries generated by rule execution on client machines and managing the merchant database 113 and the administrative ruleset database 114. The second local assistant administrative system 120 maintained by the assisted merchant performs the function of updating the local assistant data and managing the administrative data database 129.

In the preferred embodiment, the rules used by the local assistant are represented as XML text and stored in an encoded form in files. These XML rules can varies significantly from application to application and may reflect a proprietary programming language developed by the application provider. The XML encoding may be performed as follows. The XML file is first compressed using the standard zip algorithm available in Java1.1, then bits are scrambled to make the resulting binary stream harder to decode. Similarly, the data used by the local assistant are represented by XML or HTML text and stored in files. Again, the XML or HTML files are compressed using a zip algorithm and then the bits are scrambled to make the resulting binary stream difficult to decode.

Secure internet interaction between the first local assistant web server 111, the second local assistant web server 121, a client-side browser 107 and a local assistant program 104 is accomplished by use of this encoding technique together with the HTTPS secure socket layer protocol and signed certificates. This assures the user that the local assistant software has the prescribed behavior and assures the assisted merchants that the rulesets designed for them are those that are executed by the local assistant.

The administrative ruleset database 114 contains ruleset currently available for download. A ruleset in this database could be one designed for a particular assisted merchant, or a ruleset designed simply to benefit the user. For example, the ruleset may allow for customization by the user or local data management, making the use of the local assistant more appealing and widespread. The local assistant administrative ruleset manager provides functionality to agent administrators to add new rulesets, to delete obsolete rulesets, and to define updates to maintain existing rulesets. It also provides functionality to download updates and new rulesets upon request, to keep download statistics and to control the number of allowed downloads for a given ruleset. Additional information stored for each ruleset may include: name/id, date, merchant, file location (of the actual ruleset); maximum number of rules, maximum number active rules, total number of rules, number of active rules; and the start and end date of the rules.

Each rule set also contains a “feature description” that describes some of the most basic properties of the rule set, including how and when it is to be updated. The feature description contains: a name of another rule set (the update rule set), the time interval for updating and the current version number of the rule set. The update rule set is typically very small and contains information about available rule sets and their version numbers. The rules in the update rule set may specify the downloading of a new rule set to replace the current one, if the version number of the current one on the client is less than the one the update rule set specifies.

The administrative interaction database 115 contains anonymous interaction information uploaded from users' computers as a result of execution of rules that specify such actions. The protocol used for uploading in the preferred embodiment is the HTTP POST method, passing the data represented as strings. The database scheme is restricted to accept only limited information, thus preserving user privacy.

The local assistant installation download 116 is a file with executable code that will install the local assistant client-side program once the user has confirmed the download request and the user computer 100 has authenticated the connection. The local assistant program 104 can be downloaded from the local assistant administrative system web site either by directly accessing the local assistant web site, or by using special links embedded in a web document served by an assisted merchant, or other web site.

The server 150 represents any web site which stores HTML documents 137 and delivers the HTML documents 137 to the user's computer 100 upon request by the web server 131. Some documents may contain links for downloading the local assistant program. If a download link is contained in a document on an assisted merchant's site, then downloading the system will result in also downloading rulesets associated with that associated merchant.

The local assistant architecture is completely data-driven. The local assistant program is built from a very small runtime core using the same type of XML rules, data and meta-data that is available to anyone else. In other words, any application, such as the web assistant, the loyalty program assistant, and the listener assistant, is built from the core engine by the addition of a “knowledge base” of data, meta-data and rules expressed in XML, along with user interface components. When operating in conjunction with the browser, the user interface components are themselves expressed as data, in HTML. Thus, the core engine provides a highly extensible platform for delivering new applications and functionality, with minimal maintenance requirements and no required installation.

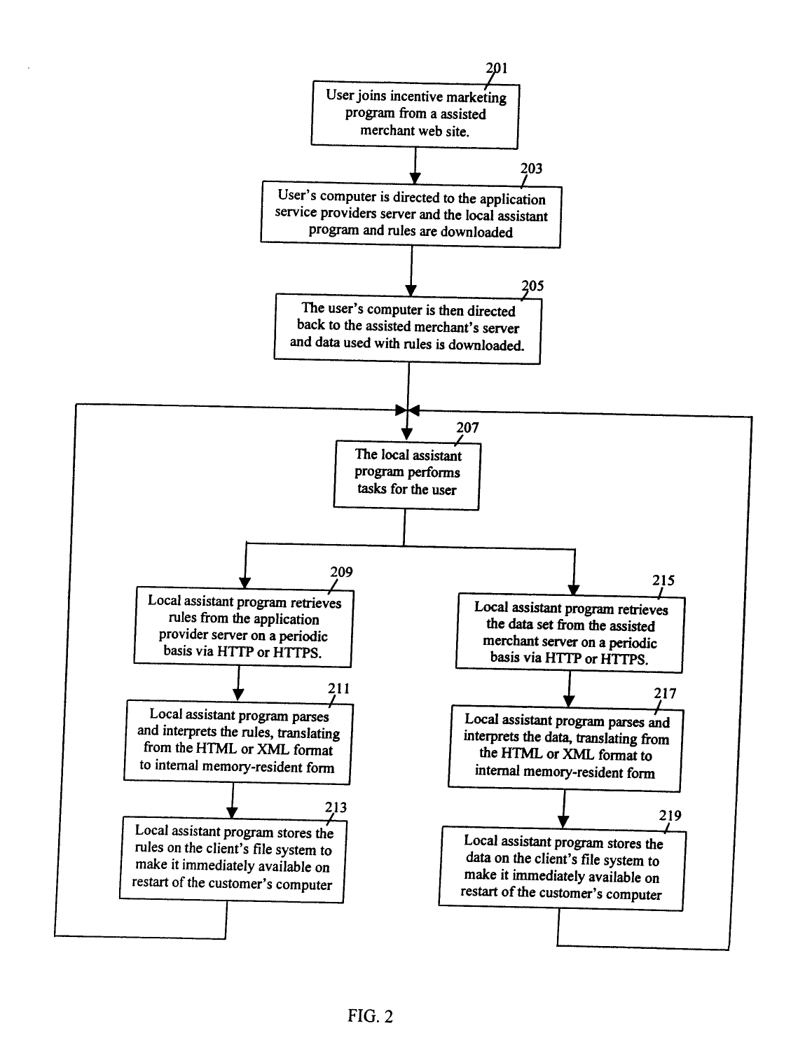

FIG. 2, is a flowchart illustrating an exemplary means by which the local assistant program is downloaded and maintained. The user first joints an incentive program through the assisted merchant's web site 201. Upon joining the incentive program, the assisted merchant's web site directs the user's web browser to the application service provider's web site where the local assistant program and current rules are downloaded 203. The user's web browser is then directed back to the assisted merchant's web site and the data for the incentive program is downloaded 205. The local assistant program then operates in accordance with the assisted merchant's incentive program 207.

Both the rules and data are periodically updated. To update the rules, the local assistant program goes to the appropriate application provider server web page and downloads the updated rules which are in HTML or XML via HTTP or HTTPS 209. The local assistant program then translates the rules from HTML or XML format into an internal memory resident form 211. The rules are stored on the user's computer and are loaded into the local assistant program when the user's computer is restarted 213. The local assistant system then returns to the normal operations.

The updated data is downloaded in a very similar manner to that of the rules. The local assistant system periodically goes to the assisted merchant server and downloads the updated data in the form of an HTML or XML table via HTTP or HTTPS 215. The data table is translated from HTML or XML into an internal memory resident form 217. The local assistant program then stores the data in a file on the user's computer and makes the data available upon restart of the computer 219. After the data download the local assistant program operates normally 207.

The normal operations of the local assistant program will vary depending upon the rules and data used by the local assistant system. In an embodiment, one of the functions performed by the local assistant system is the presentation of offers or rewards to the user in response to specific actions by the user such as URLs input and triggerstrings typed by the user.

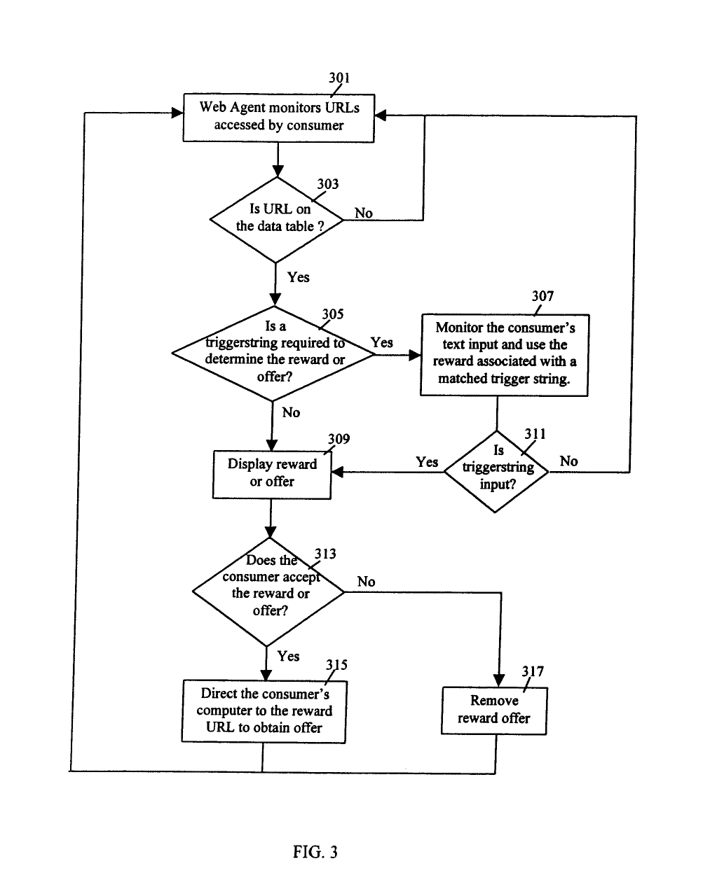

FIG. 3 is a flowchart representing the actions of the local assistant program in an offer or reward mode of operation. The local assistant program monitors the URLs accessed by the user 301. The data used with the rules contains a listing of URLs which the local assistant program recognizes and responds to. The local assistant program determines if the ULR input by the user matches a URL on the data table 303. If the ULR is not on the data table, the local assistant program goes back to the monitoring step 301. If the URL is recognized, the local assistant program checks to see if a triggerstring is also required to determine the specific offer or reward to display 305. The local assistant program displays the reward or offer 309 if a triggerstring is not required. If a triggerstring is required, the local assistant program monitors the user's inputs for the trigger string 307. The offer or reward is displayed 305 if the trigger string is detected. If the triggerstring is not detected, the local assistant program goes back to monitoring the URLs input 301.

The offer or reward may be in the form of a pop up window which the user can either accept or reject 313. Alternatively, the offer or reward may be presented as another browser window or the browser search side panel. If the offer or reward is not accepted, the pop up window is removed 317 and the local assistant program goes back to monitoring the URLs 301. If the offer or reward is accepted, a URL containing the offer or reward is displayed 315 and the local assistant program goes back to monitoring the URLs 301.

In an embodiment, the data table may be used to display various offers from merchants to the user when the local assistant program detects specific user actions. This data may be represented as simple HTML tables which can easily be created and modified by anyone with some knowledge of HTML design. The data tables are downloaded and interpreted by the local assistant program for use with the current rules. Each of these offers may be represented by a row of HTML code on the data table. The specific data for each offer in the data table may include: domain name triggering the offer, the url of the offer, the offer type, name used in offer, offer text, position of offer window, mode of offer delivery and triggerstring.

The domain field is the first basic item used for recognizing when to display an offer (but not the only thing). The domain may only include the name “amazon.com” and not any “http” or “www.” In some situations, a specific merchant may have multiple domain names which are equivalent such as Barnes & Noble which includes bn.com, bamesandnoble.com, books.com, etc. These domain names may be stored on a database of equivalent domain names to ensure that the local assistant program will respond in the event that a domain has multiple inbound locations. In another example, if the offers are targeting reader's digest, you might want to specify “shopping.readersdigest.com/rdsah/” to have the offer delivered only at the shopping page rather than the initial page.

The actions of the web agent may include directing the user's computer to a specific offer URL represented by a second field in the offer code in the data table. The actual “go to URL” construction may depend upon the offer type and may include a “fixed” stem and a variable portion. For example, the complete URL may be http://www.partner.com/reminder_landing_jsp?merchant_id=2583 or http://www.partner.com/reminder_landing.jsp?category_id=19. Alternatively, the partner rules may define the variable portion as simply “merchant_id=2583” or “category_id=19” and these entires would be displayed in the table and the remaining URL stem would be fixed in the business rules.

Another variable may be the offertype which may be written in a code which has special meaning to the rules. Each letter in the offer type field may have specific meaning as specified in Table 1. When implemented, the local assistant system can interpret the offer type code and provide the requested offer.

TABLE 1

| Letter | p | n | i | m | c |
|---|---|---|---|---|---|
| Meaning | offer at a | offer at a non- | redirecting to an | redirecting to | offer for various |
| | participating | participating | intermediate | the merchant's | categories of |
| | merchant site | merchant site | page offering | page | merchants |

Using the described translations, various types of offers can be made based upon the combination of letters used in the offertype field. For example, the offertype “pim” would be an offer at a participating merchant site (p) that redirects the end user to an intermediate page offering the merchant link (i) before arriving at that participating merchant's framed page (m). The offer type “pm” is an offer at a participating merchant site (p) that redirects the end user to that merchant's framed page (m) rather than an intermediary page. The offer type “nic” is an offer at non-participating merchant site (n) that redirects an end user to an intermediate page (i) offering various categories of merchants (c). The offer type “nm” is an offer at a non-participating merchant site (n) that redirects the end user to a competitive participating merchant site (m). The offer type “nim” is an offer at a non-participating merchant site (n) that redirects the end user to an intermediate page (i) before arriving at that competitive merchant site (m).

The data may also have a “name” field for text used to fill the offer template. For example, the name “Amazon” may be used in specific merchant offers seen in “pim”, “pm”, “nm” or “nim” type offers while the name “Books” may be seen in a category offer seen in an “nic” type offer. The name field can alternatively be left blank, if not needed for the offer type. The data may also have an offertext field which is used to fill in the offer template. For example, the text in the name field may be: “5%” or “10 points”. Again, the offertext field can be left blank if not needed for the offer type.

The data may also specify the position of the offer window in relation to the browser. The position field may use letters to indicate the position of the offer window. The position field may use two letters to indicate the offer position in the browser. Again each letter may have a specific meaning as indicated in Table 2. Using the specified codes, “1t” would display the offer at the left top and “rb” would display the offer at the right bottom.

TABLE 2

| Letter | 1 | c | r | t | c | b |
|---|---|---|---|---|---|---|
| position | first | first | first | second | second | second |
| meaning | left | center | right | top | center | bottom |

The data may also have a mode field which dictates the offer delivery behavior by merchant (e.g., whether auto-redirect allowed). The letter “a” may indicate auto-redirect. When this mode is detected, the local assistant system automatically redirects the browser to the URL. Alternatively, if the mode field is blank then auto-redirect mode is not implemented and the browser is not automatically redirected anywhere.

In some situations, the domain name may be insufficient to distinguish the offer to display and the local assistant program may determine an offer based upon a triggerstring input by the user. When a triggerstring field is provided, the offer will only be delivered if the specified URL is detected and all trigger strings are present. For example, if go.com is the domain in the data, the system would deliver an offer on all “go.com” domains (“abcnews.go.com”, “espn.go.com”, “disney.go.com”) unless additional trigger strings are specified such as “disney.store” for The Disney Store. In another example, if cc-inc.com (a computer merchant selling both PC and Macintosh computer) is the domain, the offer might want to specify either the Mac Mall or PC Mall depending on desired target offer. The trigger string could be either “macmall” or “pcmall.” The application provider may keep a database of trigger strings that may be helpful in identifying more exact locations when an offer is intended to be delivered.

The described data in table format should be available via fixed URLs (one for member, the other for non-member data) on the assisted merchant's standard servers which are accessible through a high-speed network. The client reads the data at login and while connected to the Internet. The assisted merchant may provide “symbolic” (non-IP) URL to the table for the rule set to use, so that multiple versions of the table can be active for testing purposes under different IP addresses. The assisted merchant can then test the modified data effects locally by adding/removing entries on the data table before releasing to the administrative assistant programs. The data table may be formatted in a simple HTML page, as follows:

<html>
<body>
<table>
rows of data
</table>
</body>
</html>

where each row may consist of the following elements:

<tr><td>domain</td><td>gotourl</td><td>offertype</td><td>name</td><td>offertext<
/td><td>position</td><td>mode</td><td>triggerstring</td></tr>

The codes and formats described are exemplary only. It is anticipated that various other codes and formats can be used by the inventive system. Because the data is interpreted by the local assistant program and used with the current rules, the data format is dictated by the rules and local assistant program.

Although the rules and data control the operation of the local assistant program, the user can alter some of these functions through a control panel which is a component of the local assistant program. The control panel allows the user to control the basic operations of the local assistant program. For example, a control panel may allow the user to set the local assistant program to automatically perform functions, ask the user before performing the functions or disable and re-enable the program operation while retaining the program on the computer memory. The control panel may be accessed through the browser icon, on a browser context menu or through a link in window. The control panel also allows the program to be uninstalled from the computer.

Using the Local Assistant program, the Assisted Merchant can present special offers, tailored precisely to the interests of a target user, at exactly the moment the user is looking for products like the assisted merchant's products. In one scenario, an assisted merchant can present a price quote for a book every time the user asks for a quote from another book vendor. In another scenario, a merchant whose role is intermediary for a loyalty program an present an offer to a user to purchase via one or more loyalty program merchants when the user is shopping for products offered by these merchants. In yet another scenario, an assisted merchant can present a list of available CDs by an artist that the user is currently playing. The local assistant system also has the benefit of being virtually risk free because it doesn't require any modifications to the assisted merchant web site or e-commerce software. All of the promotions are executed in compact downloads in the user's browser and no data needs to be transmitted directly back to the assisted merchant site.

Another feature of the local assistant system is the ability to avoid presenting offers in certain situations. Many merchant web sites have affiliate relationships and interference by the local assistant system during web navigation between these affiliates should be avoided. A typical affiliate is a site that contains links to the merchandise of another site. For example, an affiliate to a large shopping web site such as Amazon.com might display a link (“affiliate link”) to a book sold on Amazon. When that link is followed to Amazon and the user buys the book, the affiliate gets a fee from amazon. The local assistant system should not interfere with this type of transaction by directing the user to Amazon through other means.

The local assistant detects when a user is being directed to a merchant site through an affiliate transaction and refrains from presenting offers. The vast majority of affiliate transactions are monitored through a small number of middlemen, such as linksynergy, bfast etc. However, some web sites such as Amazon monitor their own affiliate transactions. The local assistant recognizes potential affiliate links because they often contain the names of these middlemen. The local assistant system first examines the url of the browser. If the url contains names of well-known middlemen, the local assistant refrains from presenting offers. Similarly, if the url contains specific industry codes such as “afsrc” that indicate affiliation, the local assistant refrains from presenting offers.

The local assistant also examines url's that the user might have clicked or typed in order to navigate the browser to its current state that have been recorded during a short time interval preceding the time of examination. These previous url's are obtained by monitoring event data coming from the browser, such as text inputs, what's under the mouse cursor, what has been clicked, status information displayed by the browser while navigating etc. Again, if any one of these url's indicate an affiliate transaction as described above, The local assistant refrains from presenting offers.

Although the local assistant program has been described with reference to merchants presenting offers to users, the inventive system can also be used with various other applications. For example, the inventive system can be used with various other applications such as: a web assistant, a user loyalty program, CD listener and a news retrieval system.

A typical sequence of events is described when the inventive system is used with a web assistant application. The user uses the web browser 107 to obtain a web document retrieved from a targeted site 150. The user views the retrieved document and the local assistant client program 104 detects that a new page is being viewed by the user. The rules and data used to analyze the web document being viewed are obtained from the rule database 105. For example, if the document is an amazon.com catalog page for a book, then the appropriate rule and data may be used to determine the ISBN of the book being considered. The local assistant program 104 then looks at competing provider prices for the same book. It extends the current information context by associating the word following “ISBN” in an HTML document to the name “isbn” to the information context.

An Assisted Merchant server 121 provides data which is used with the rules by the local assistant program to define the conditions and forms of offers presented to the user. For example, the local assistant program may obtain the book price from other merchants and only submit an offer if the other merchant's price is lower than the Amazon price. Alternatively, the assisted merchant might have a rule that meets or underbids the price of an amazon.com site, but offers its standard price with free shipping when bidding against barnsandnoble.com. In either case, the data obtained from the Assisted Merchant will contain the conditions for retrieving and analyzing the assisted merchant's catalog page containing the item of interest. The local assistant program will then to use this data with the rules to produce an offer. The local assistant program may then calculate the total cost of each offer and display the prices from a plurality of merchants to assist the user in finding the least expensive merchant from which to purchase the book. The web assistant program can be easily updated as discussed so that the latest offers are available to the web agent user.

The local assistant program can also be used with a loyalty program as described below. The user views a web document from a targeted site 150 and the local assistant client program uses target document rules and data to extract relevant information, for example, the ISBN and price of a book. An assisted merchant using the loyalty program assistant will define rules for determining the participating merchants and for each merchant, relevant attributes and a link to a loyalty program entry to their site. For example, schoolcash.com is an intermediary for a school rebate program whereby participating merchants donate a percentage of each purchase through this program to the school of the purchaser's choice. The relevant attribute in this case is the percent rebate for each merchant that sells the product in question may differ. Finally there are rules for combining the premium and price data to produce an offer. For each loyalty assisted merchant, the local assistant client program executes the associated rulesets and data.

As in the case on the web assistant scenario, an offer window is made visible, offers are presented and the local and administrative interaction databases may be updated. The offer reminds the user of the Amazon rebate rate and provides a convenient link for the user to make a purchase through the loyalty program. The user computer's ruleset database may contain both web and loyalty assistant rules and data. In this case, the applicable rules and data from both the web assistant and loyalty program can be executed simultaneously. The use of multiple applications can be controlled by the user using settings in the local assistant program.

In another application, the local assistant program may also be used with a listener assistant. For example, when the user inserts a CD into the CD player (interaction point 101) and a media player application (interaction manager 102) is started, for example WinAmp. The local assistant client program 104 becomes aware that a CD is playing by interacting with the system resource manager 103 and requests artist information from the WinAmp player 102. A listener assisted merchant will have data which generates offers related to the artist playing. For example, the amazon.com or cdnow.com might have rules to collect a list of all the CDs by that artist in their catalog and present this along with links and possibly price/availability information. An online ticket agency might have rules to gather a list of all the upcoming concerts by this artist (and possibly artists considered to be related in some way) for which the agency sells tickets. Other information, such as reviews and articles relating to the artist, could also be collected. As in the case of the web and loyalty assistants, any offers are produced are displayed and updates to the local and administrative interaction databases are made. For example, when a user was listening to a Paul Simon recording, the information obtained by the web agent can include an album offer (from Amazon), links to a review, concert information, and a news group article.

The following is an example of the local assistant program used with a news notification application. The news assistant rules and data performs the task of periodically retrieving news summary documents from the news assisted merchant's site. As an example, a rule that retrieves current news from cnet.com may specify that news should be retrieved every 15 minutes. Execution of the rule and data sets a flag used to check whether any new news was found. The cnet.com server may also contain data (now shown) to analyze the summary page and collect a list of current news items, each item containing a description and a link to the actual news document. The local interaction data contains a history of news items already seen and also a list of topics of interest to the user (maintained using the customization application described below).

In the depicted scenario, the local assistant client program 104 executes the cnet news gather task. A news summary page is retrieved from the news assisted merchant's web site and a news window is made visible. This window may initially contain advertisement provided by new assisted merchant. Using the news summary and the history and news preferences obtained from the local interaction database, a list of new items on topics of interest is generated and displayed in the news window. The local interaction database is then updated to reflect the most recent new retrieved.

Data obtained from multiple assisted merchant servers can be used with the same ruleset provided by the application provider. In many cases the data obtained from different assisted merchants will be compatible because the merchants do not compete against one another and the data does not cause the actions of the local assistant program to be conflicted. If however, data from competing assisted merchants is requested by the user, the system may ask the user to decide which assisted merchant's data is to be used. For example, if the user uses data from a first book merchant server and then attempts to download data from a completing second book merchant server, the local assistant system will ask the user to decide which data to use. By choosing the data to use, the system will not be conflicted when responding to observed actions.

While the invention has been described herein with reference to certain preferred embodiments, these embodiments have been presented by way of example only, and not to limit the scope of the invention. Accordingly, the scope of the invention should be defined only in accordance with the claims that follow.

What is claimed is:

1. An internet based system for displaying information on a computer comprising:
a first administrative system that stores a set of rules;
a second administrative system that stores data; and
a local assistant program running on the computer which uses the rules and the data to define actions to be taken by the local assistant program in response to recognized computer inputs;
wherein the local assistant program downloads the rules from the first administrative system and the data from the second administrative system and the local assistant program monitors the computer and performs the defined actions in response to the recognized computer inputs.

2. The internet based system for displaying information of claim 1, wherein the local assistant program monitors URLs accessed by the computer and if the URLs include at least one of the recognized computer inputs the local assistant program displays information related to the URLs.

3. The internet based system for displaying information of claim 1, wherein the local assistant program monitors trigger strings typed into the computer and if the trigger strings are recognized the local assistant program displays information related to the trigger strings.

4. The internet based system for displaying information of claim 2, wherein the information displayed is a pop up window, another browser window or the browser search side panel.

5. The internet based system for displaying information of claim 2, wherein the information is an offer for a discount on the purchase of products or services.

6. The internet based system for displaying information of claim 5, wherein the computer is directed to an offer URL if the discount offer is accepted.

7. The internet based system for displaying information of claim 2, wherein the information is an offer for a reward in an incentive program.

8. The internet based system for displaying information of claim 7, wherein the computer is directed to a reward URL if the reward offer is accepted.

9. The internet based system for displaying information of claim 1, wherein the local assistant program is part of a first incentive program and when a second local assistant program for a second incentive program is downloaded onto the computer a message asking the user to decide between the first incentive program and the second incentive program is displayed.

10. The internet based system for displaying information of claim 1, wherein the local assistant program does not display an offer when an affiliate transaction is detected.

11. The internet based system for displaying information of claim 1, wherein when the local assistant detects that the computer is performing a first search based upon a first URL and the local assistant detects the subject being search based upon a triggerstring, the local assistant performs a second search using the triggerstring.

12. The internet based system for displaying information of claim 11, wherein results of a second search are displayed.

13. The internet based system for displaying information of claim 9, wherein when the first incentive program or the second incentive program is selected, the other incentive program is deleted from the computer.
